(19) United States
(12) Patent Application Publication
(10) Pub. No.: US 2026/0302494 A1
(43) Pub. Date: Oct. 1, 2026

(54) POWER DISTRIBUTION APPARATUS

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventor: Yusuke ISAJI, Osaka-shi, Osaka (JP)

(73) Assignees: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(21) Appl. No.: 19/474,862

(22) PCT Filed: Apr. 11, 2024
(86) PCT No.: PCT/JP2024/014712

§ 371 Date: Oct. 13, 2025

(30) Foreign Application Priority Data
Apr. 17, 2023 (JP) 2023-067169

(51) Int. Cl. H01M 50/269; H01H 50/02; H02J 7/50

(52) U.S. Cl. CPC H01M 50/269; H01H 50/021; H02J 7/575

(57) ABSTRACT

A power distribution apparatus includes: a first relay connected to a first negative-side line of a first circuit; a second relay connected to a second positive-side line of a second circuit; a third circuit that connects the first negative-side line upstream of the first relay and the second positive-side line upstream of the second relay; a third relay connected to the third circuit; a positive-side connector portion that connects the first positive-side line and the second positive-side line in parallel downstream of the second relay; a negative-side connector portion that connects the first negative-side line and the second negative-side line in parallel downstream of the first relay; and a positive-side output portion and a negative output portion connected to the downstream sides of the positive-side connector portion and the negative-side connector portion, respectively.

### CROSS-REFERENCE TO RELATED APPLICATIONS

This application is the U.S. national stage of PCT/JP2024/014712 filed on Apr. 11, 2024, which claims priority of Japanese Patent Application No. JP 2023-067169 filed on Apr. 17, 2023, the contents of which are incorporated herein.

### TECHNICAL FIELD

The present disclosure relates to a power distribution apparatus.

### BACKGROUND

WO2011-104792A discloses a vehicle battery pack including a first battery and a second battery composed of a plurality of assembled batteries. For a battery pack that includes two batteries, if the connected state of the two batteries can be switched between a parallel connection and a series connection, the battery pack can be used in a wider range of applications, making it more convenient. For this reason, studies are being conducted into a power distribution apparatus for switching the connected state of two batteries.

However, when constructing a power distribution apparatus for switching the connection of two batteries between series and parallel, in addition to relays connected to the positive-side lines of each battery, another relay needs to be connected to the negative-side line of one of the batteries and yet another relay needs to switch a connection between the negative-side line of one battery and the positive-side line of the other battery between a conductive state and a cutoff state. For this reason, an increase in the number of parts and an associated increase in the size of a power distribution apparatus have been unavoidable.

For this reason, the present disclosure discloses a power distribution apparatus that is capable of switching the connection between two batteries between series and parallel and of miniaturizing the apparatus as a whole.

### SUMMARY

A power distribution apparatus according to an aspect of the present disclosure includes: a first circuit including a first positive-side input portion and a first negative-side input portion connected to a first battery; a second circuit including a second positive-side input portion and a second negative-side input portion connected to a second battery; a first relay connected to a first negative-side line of the first circuit; a second relay connected to a second positive-side line of the second circuit; a third circuit that connects the first negative-side line upstream of the first relay and the second positive-side line upstream of the second relay; a third relay connected to the third circuit; a positive-side connector portion that connects a first positive side line and the second positive-side line in parallel downstream of the second relay; a negative-side connector portion that connects the first negative-side line and a second negative-side line in parallel downstream of the first relay; and a positive-side output portion and a negative side output portion connected to respective downstream sides of the positive side connector portion and the negative-side connector portion.

### Advantageous Effects

According to the present disclosure, it is possible to provide a power distribution apparatus that is capable of switching a connection between two batteries between series and parallel and miniaturizing the apparatus as a whole.

### BRIEF DESCRIPTION OF DRAWINGS

FIG. 1 is a perspective view of a power distribution apparatus according to a first embodiment.

FIG. 2 is a plan view of the power distribution apparatus depicted in FIG. 1.

FIG. 3 is a perspective view depicting the power distribution apparatus in FIG. 1 in a state where a lower case has been removed.

FIG. 4 is a perspective view depicting components that construct a first circuit, a second circuit, and a third circuit of the power distribution apparatus depicted in FIG. 1, as viewed from the front.

FIG. 5 is a perspective view from the rear side of the components constructing the first circuit, the second circuit, and the third circuit depicted in FIG. 4.

FIG. 6 is a perspective view depicting, in an exploded state, some components of the power distribution apparatus depicted in FIG. 1.

FIG. 7 is a perspective view depicting a connected structure, in which a first base member and a second base member are connected to each other, in the power distribution apparatus depicted in FIG. 1.

FIG. 8 is a plan view of the connected structure of the first base member and the second base member depicted in FIG. 7.

FIG. 9 is an enlarged vertical cross-sectional view depicting a principal part of a cross section along a line IX-IX in FIG. 8.

FIG. 10 is a perspective view depicting, from a left side, a first base member that constructs the power distribution apparatus depicted in FIG. 1.

FIG. 11 is a perspective view, from a right side, of the first base member depicted in FIG. 10.

FIG. 12 is a plan view of the first base member depicted in FIG. 10.

FIG. 13 is a circuit diagram showing the electrical configuration of the power distribution apparatus depicted in FIG. 1.

FIG. 14 is a circuit diagram showing a state in which a first battery and a second battery are connected in parallel by the power distribution apparatus depicted in FIG. 1.

FIG. 15 is a circuit diagram showing a state in which the first battery and the second battery are connected in series by the power distribution apparatus depicted in FIG. 1.

### DETAILED DESCRIPTION OF PREFERRED EMBODIMENTS

Several embodiments of the present disclosure will first be listed and described in outline.

In a first aspect, a power distribution apparatus according to an aspect of the present disclosure is a power distribution apparatus including: a first circuit including a first positive side input portion and a first negative side input portion connected to a first battery; a second circuit including a second positive-side input portion and a second negative-side input portion connected to a second battery; a first relay connected to a first negative-side line of the first circuit; a second relay connected to a second positive-side line of the second circuit; a third circuit that connects the first negative side line upstream of the first relay and the second positive side line upstream of the second relay; a third relay connected to the third circuit; a positive-side connector portion that connects a first positive-side line and the second positive side line in parallel downstream of the second relay; a negative-side connector portion that connects the first negative-side line and a second negative side line in parallel downstream of the first relay; and a positive-side output portion and a negative-side output portion connected to respective downstream sides of the positive side connector portion and the negative-side connector portion.

With the above power distribution apparatus according to an aspect of the present disclosure, the first battery and the second battery can be connected in parallel by turning ON the first relay connected to the first negative-side line of the first circuit and the second relay connected to the second positive side line of the second circuit and turning OFF the third relay. Also, by turning OFF the first relay and the second relay and turning ON the third relay, the first battery and the second battery can be connected in series and a higher voltage output than during parallel connection can be outputted from the positive side output portion and the negative-side output portion. In addition, the third relay is provided in a third circuit that connects the first negative side line upstream of the first relay and the second positive-side line upstream of the second relay. For this reason, by using only three relays, it is possible to switch between a series and parallel connection of the two batteries and possible to achieve miniaturization by using a small number of parts. Additionally, a third circuit including the third relay can be provided between the first relay and the second relay with favorable space efficiency, which makes it possible to miniaturize the apparatus as a whole.

In a second aspect, it is preferable for the power distribution apparatus according to the first aspect to further include: a first current sensor connected to the first positive-side line of the first circuit; and a second current sensor connected to the second negative-side line of the second circuit, where the positive-side connector portion is connected to the first positive-side line downstream of the first current sensor and the negative side connector portion is connected to the second negative-side line downstream of the second current sensor. The first current sensor is connected to a first positive-side line, to which the first relay is not connected, and the second current sensor is connected to a second negative-side line, to which the second relay is not connected. By doing so, it is possible for the first and second current sensors to be installed by making good use of the space on the lines on which relays are not connected, and the arrangement of the first and second relays and the first and second current sensors that makes efficient use of space enables the apparatus as a whole to be further miniaturized.

The first and second current sensors are connected to the first positive-side line and the second negative-side line upstream of the positive and negative connector portions, respectively. By doing so, the current states can be stably measured by the first and second current sensors alone for both the series connection and parallel connection states. In particular, by providing the first current sensor and the second current sensor upstream of the positive-side connector portion and the negative-side connector portion, the first current sensor and the second current sensor can be installed in a manner that makes efficient use of space without being restricted by the positive-side output portion and the negative-side output portion that are provided downstream of the current sensors.

In a third aspect, it is preferable for the power distribution apparatus according to the first or the second aspect to further include a fuse that is connected in series to the third relay of the third circuit, and for a region where the third relay is disposed and a region where the fuse is disposed to overlap in a mounting direction of the third relay. Since the third circuit is equipped with a fuse connected in series to the third relay, if an unexpected overcurrent flows when the third relay is connected, the third circuit can be cut off to prevent damage to the batteries and/or devices located downstream. Additionally, since the region where the third relay is disposed and the region where the fuse is disposed overlap in the mounting direction of the third relay (for example, the vertical direction), it is possible to prevent the apparatus from becoming larger in the width direction of the apparatus (that is, the horizontal direction) that intersects the mounting direction.

In a fourth aspect, it is preferable for the power distribution apparatus according to the second aspect to include: a first base member on which the first circuit is mounted; and a second base member on which the second circuit is mounted, for the first base member and the second base member to each include a relay mounting portion, a current sensor mounting portion, and an additional mounting portion, for a third circuit mounting portion to be formed by connecting the additional mounting portions by assembling the first base member and the second base member together, and for the third circuit to be mounted on the third circuit mounting portion.

Since the third circuit mounting portion on which the third circuit is mounted is formed by assembling a first base member, on which the first circuit is mounted, and a second base member, on which the second circuit is mounted, it is possible to provide a mounting region for the third circuit, which switches between series and parallel of the first battery connected to the first circuit and the second battery connected to the second circuit, with a small number of parts and without the need for a new base member. In addition, since the third circuit mounting portion can be constructed by utilizing spaces (the additional mounting portions) of the first and second base members on which the first and second circuits are mounted, the power distribution apparatus can be used in the same way even when the third circuit is not required, which makes it possible to provide a highly versatile power distribution apparatus.

In a fifth aspect, it is preferable for the power distribution apparatus according to the fourth aspect to further include a fuse that is connected in series to the third relay of the third circuit, for the third circuit mounting portion to include: a fuse mounting portion on which the fuse is mounted; and a third relay mounting portion on which the third relay is mounted and which includes, in a mounting direction of the fuse, the fuse mounting portion and a periphery thereof, and for the third relay mounted on the third relay mounting portion to overlap the fuse in the mounting direction of the third relay. The fuse mounting portion and the third relay mounting portion in the third circuit mounting portion can be overlapped in the mounting direction of the third relay, that is, in the thickness direction of each base member, which makes it possible to miniaturize the power distribution apparatus while providing a third circuit mounting portion on which the third circuit, which switches the first battery and the second battery between series and parallel, is mounted.

In a sixth aspect, in the power distribution apparatus according to the fourth or the fifth aspect, it is preferable for the first base member and the second base member to have a same shape, for the additional mounting portion to be disposed at one end in a length direction of each of the base members, for the additional mounting portion to be provided so as to be off-center toward one side in a width direction and have a width dimension that is smaller than another end in the length direction of each of the base members, for an inner edge in the width direction of the additional mounting portion to be provided with a mating portion with a polygonal cross-sectional shape at the one end in the length direction of the additional mounting portion, for a mating hole, which has a same cross-sectional shape as the mating portion and into which a mating portion fits, to be provided at the other end in the length direction of the additional mounting portion, and for the third circuit mounting portion, which is produced by connecting the additional mounting portions by assembling the first base member and the second base member together, to be formed by mating the mating portion and the mating hole of the second base member, which has been disposed in an orientation that is rotated by 180° around a center axis in a plate thickness direction with respect to the disposed orientation of the first base member, with the mating hole and the mating portion of the first base member.

The first base member and the second base member have the same shape and can use the same base member, which reduces the manufacturing cost and simplifies parts management. Additionally, when assembling the first base member and the second base member, it is sufficient to merely rotate the members by 180° and mate together the mating portions and mating holes, which are polygonal in cross section and are provided on each base member, which makes the assembly process simple and can reliably prevent rotational displacement between the first base member and the second base member after assembly through engagement of the mating portions and the mating holes that are polygonal in cross section.

In a seventh aspect, in the power distribution apparatus according to the sixth aspect, it is preferable for an outer peripheral surface of each base member to be provided with a locking protrusion and a locking recess, and when the first base member and the second base member are assembled, for the locking protrusions to mate with the locking recesses and restrict separation of the first base member and the second base member. By providing the locking projections and locking recesses on the outer peripheral surfaces of the base members, which have the same shape, it is possible, when assembling the first base member and the second base member, to prevent separation in the assembling direction by combining the locking projections and the locking recesses. By doing so, it is possible to stably maintain the assembled state of the first base member and the second base member without increasing the number of parts.

Preferred embodiments of the present disclosure are described in detail below with reference to the accompanying drawings. Note that the present disclosure is not limited to the embodiments given here, is indicated by the claims, and is intended to include all changes within the meaning and scope of the patent claims and their equivalents.

### First Embodiment

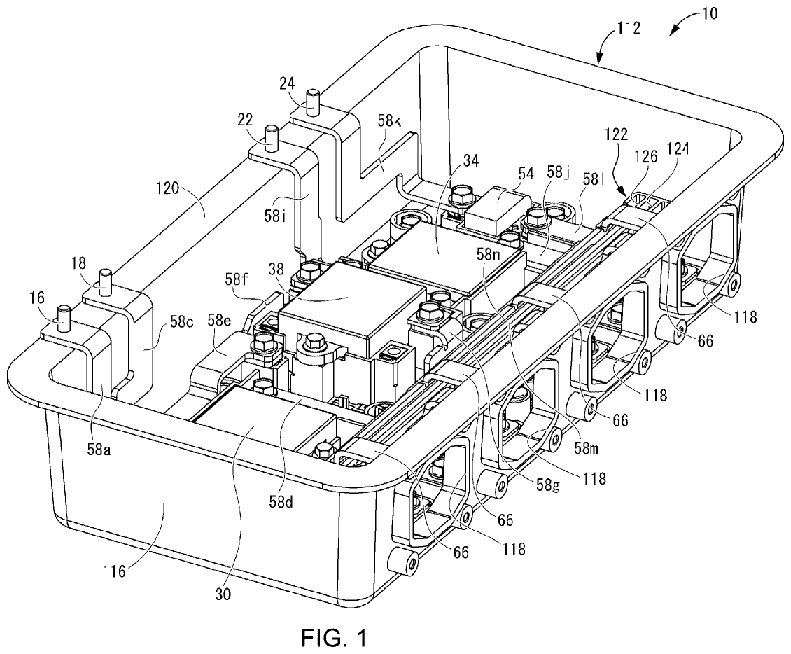

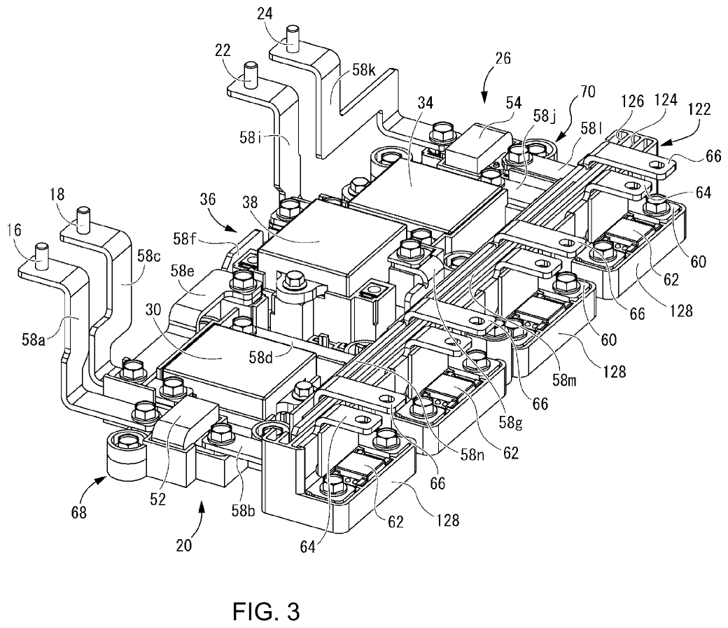

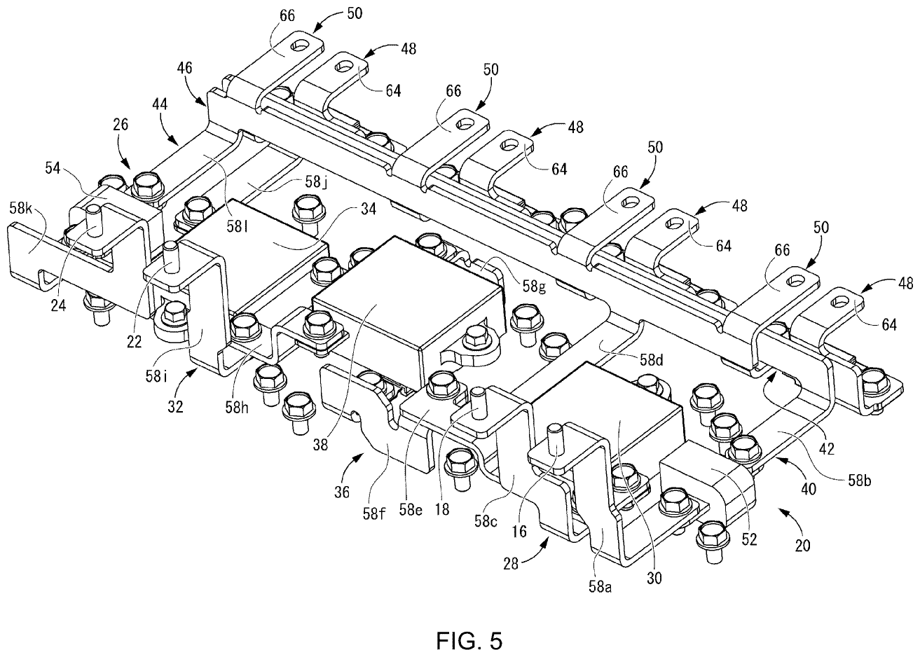

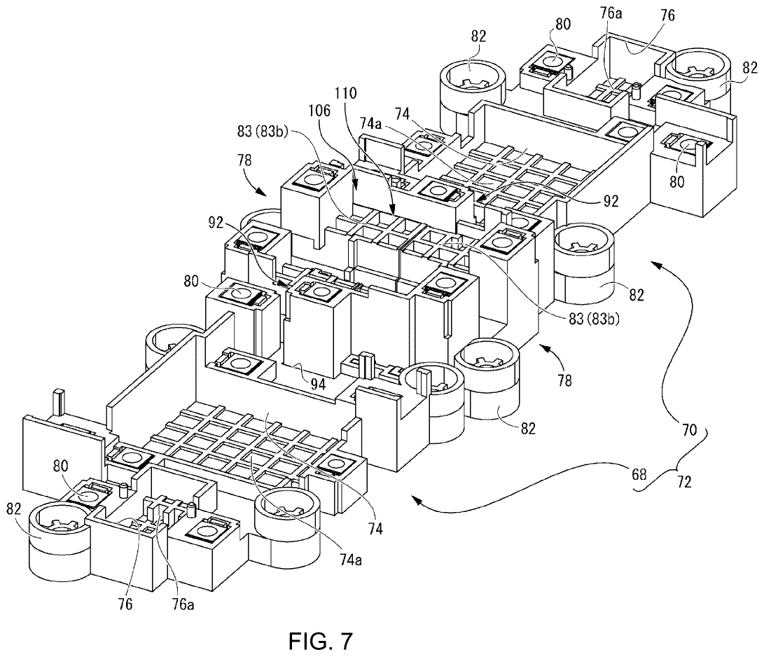

A power distribution apparatus 10 according to a first embodiment of the present disclosure will now be described with reference to FIG. 1 to FIG. 15.

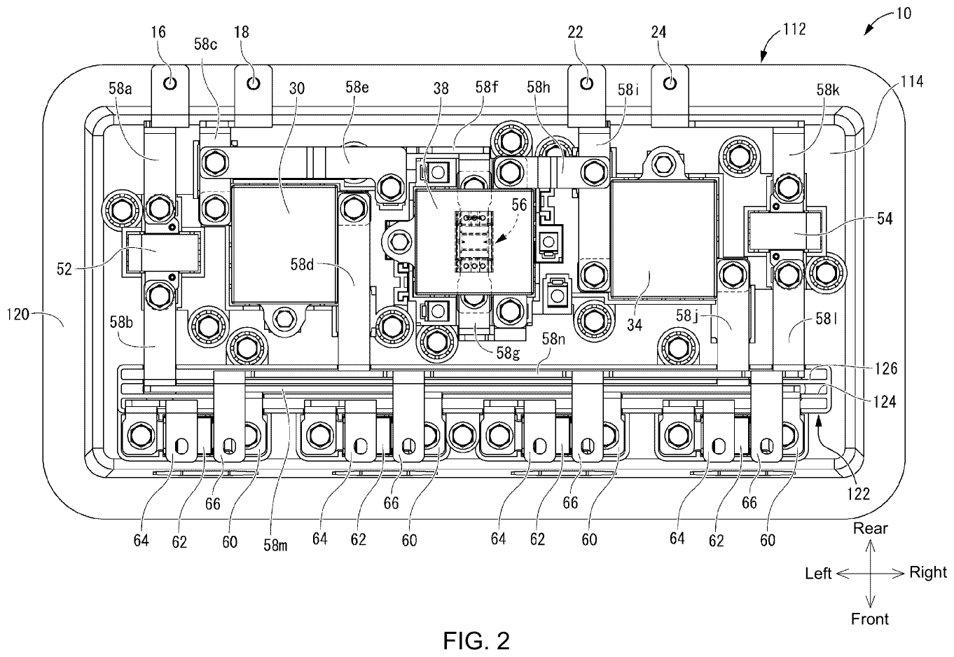

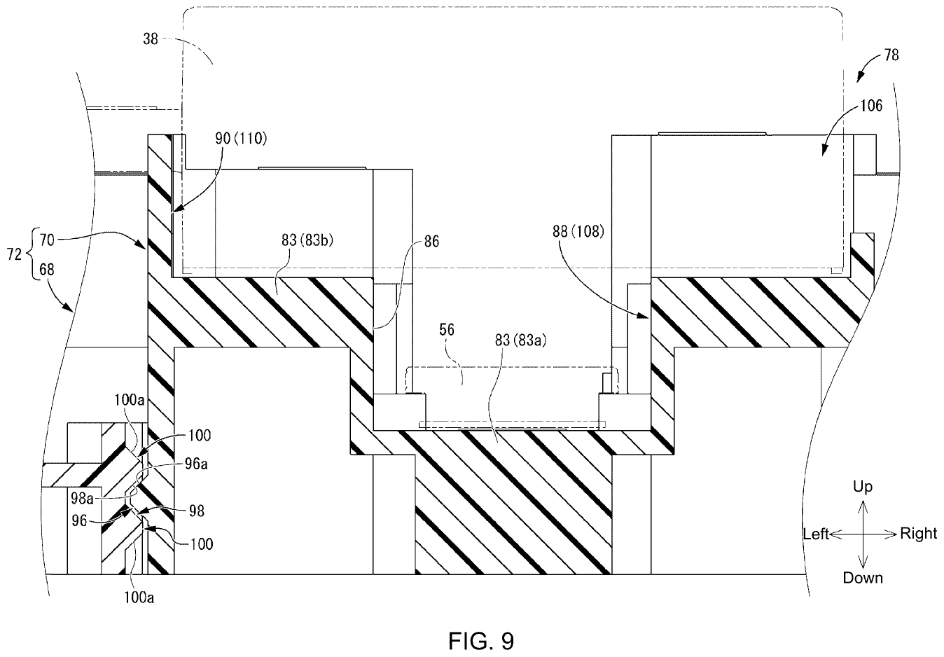

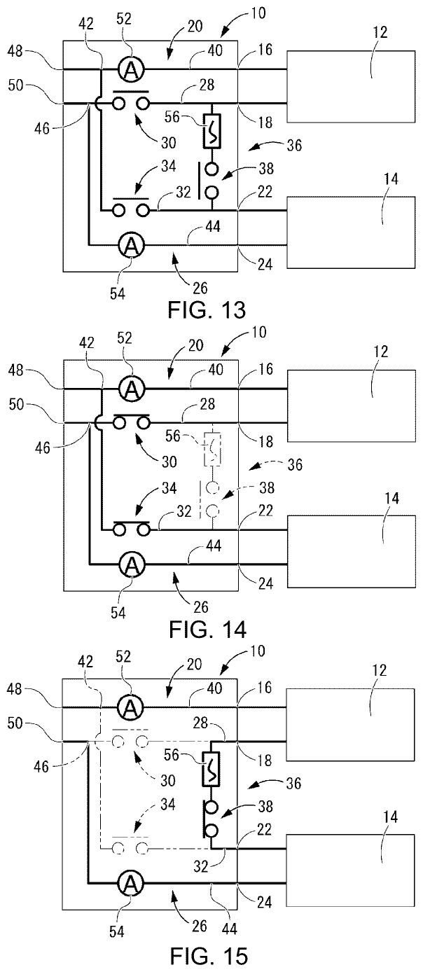

The power distribution apparatus 10 is mounted in an electric vehicle or a hybrid vehicle, for example, and includes circuits that extend from a power source to various types of publicly known auxiliary devices (not depicted), such as power steering, an electric parking brake, lights, a wiper driving unit, a navigation device, and an air conditioner. In particular, as depicted in FIG. 13 and the like, the power distribution apparatus 10 according to the first embodiment is configured to be connected to a first battery 12 and a second battery 14 that serve as power sources, and the power distribution apparatus 10 is configured to switch the connection state of the first battery 12 and the second battery 14 between series and parallel. Note that although it is possible to dispose the power distribution apparatus 10 in any orientation, in the following description, the expression “up” refers to the upward direction in FIG. 9, “down” refers to the downward direction in FIG. 9, “front” refers to downward in FIG. 2, “rear” refers to upward in FIG. 2, “left” refers to leftward in FIG. 2, and “right” refers to rightward in FIG. 2. Also, when a plurality of members are the same, reference numerals may be assigned to only some of the members and may be omitted for other members.

### Power Distribution Apparatus 10

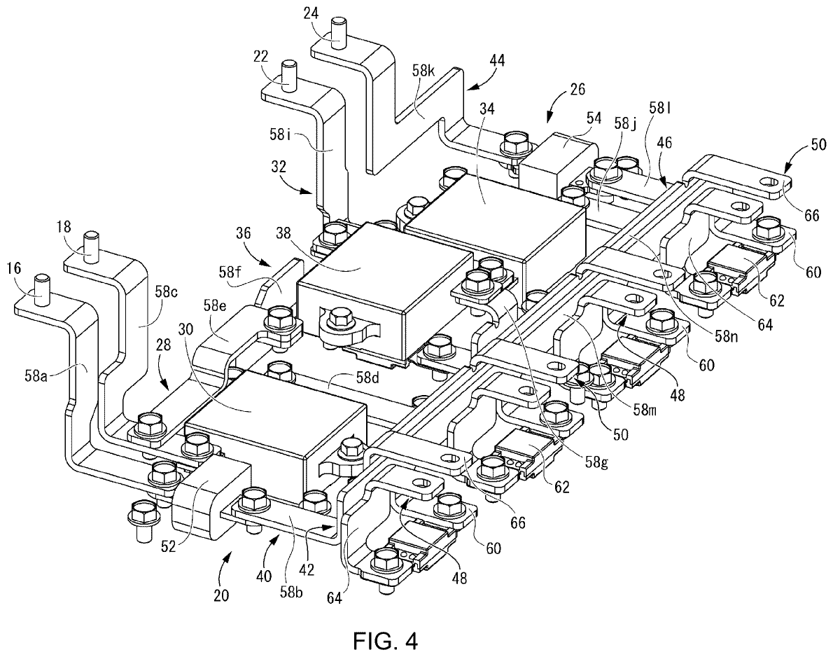

First, the electrical configuration of the power distribution apparatus 10 will be described with reference to FIGS. 4, 5, 13, and the like. The power distribution apparatus 10 includes a first circuit 20, which includes a first positive-side input portion 16 and a first negative-side input portion 18 to be connected to the first battery 12, and a second circuit 26, which includes a second positive-side input portion 22 and a second negative-side input portion 24 to be connected to the second battery 14. A first relay 30 is connected to a first negative-side line 28 in the first circuit 20, and a second relay 34 is connected to a second positive-side line 32 in the second circuit 26.

A position on the first negative-side line 28 upstream of the first relay 30 and a position on the second positive-side line 32 upstream of the second relay 34 are connected by a third circuit 36. A third relay 38 is connected to the third circuit 36. Downstream of the second relay 34, a first positive side line 40 and the second positive-side line 32 are connected in parallel by a positive-side connector portion 42, and downstream of the first relay 30, the first negative-side line 28 and a second negative-side line 44 are connected in parallel by a negative-side connector portion 46. The power distribution apparatus 10 includes positive side output portions 48 and negative-side output portions 50 connected downstream of the positive-side connector portion 42 and the negative-side connector portion 46, respectively.

Here, for the first positive and negative-side lines 40, 28 and the second positive and negative-side lines 32, 44, the expression “upstream” refers to the side where the first positive and negative-side input portions 16, 18 and the second positive and negative-side input portion 22, 24 to be connected to the first battery 12 and the second battery 14 are provided. The expression “downstream” refers to the side where the positive side output portions 48 and the negative side output portions 50 to which loads (auxiliary devices), not depicted, are connected are provided.

Note that in the circuit diagram depicted in FIG. 13, the first, second and third relays 30, 34, 38 are all OFF, indicating a state where no power is supplied to the power distribution apparatus 10 from the first battery 12 or the second battery 14. In the circuit diagram depicted in FIG. 14, the first and second relays 30, 34 are ON and the third relay 38 is OFF, and to clearly indicate that the third circuit 36 is not in a conductive state, the third circuit 36 is depicted using two-dot chain lines. In addition, in the circuit diagram depicted in FIG. 15, the first and second relays 30, 34 are OFF and the third relay 38 is ON, and to clearly indicate that parts of the first circuit 20 and the second circuit 26 are not in a conductive state, such parts of the first circuit 20 and the second circuit 26 are indicated using two-dot chain lines.

Although there are no particular limitations on the components mentioned above that construct the electric circuit in the power distribution apparatus 10, in the first embodiment, the first battery 12 and the second battery 14 are both known 48V batteries. In addition, the first relay 30 connected in the first circuit 20, the second relay 34 connected in the second circuit 26, and the third relay 38 connected in the third circuit 36 are all known mechanical relays.

The first positive-side line 40 and the first negative-side line 28 are power lines connected to an anode side (or “positive side”) and the cathode side (or “negative side”), respectively, of the first battery 12. The first circuit 20 is configured to include the first positive and negative-side lines 40, 28, the first relay 30, and a first current sensor 52, which will be described later. The second positive-side line 32 and the second negative-side line 44 are power lines connected to an anode side (or “positive side”) and the cathode side (or “negative side”), respectively, of the second battery 14. The second circuit 26 is configured to include the second positive and negative-side lines 32, 44, the second relay 34, and a second current sensor 54, which will be described later.

In particular, in the first embodiment, the first current sensor 52 is connected to the first positive-side line 40 in the first circuit 20, and the second current sensor 54 is connected to the second negative-side line 44 in the second circuit 26. Downstream of the first current sensor 52, the positive-side connector portion 42 mentioned earlier is connected to the first positive-side line 40, and downstream of the second current sensor 54, the negative-side connector portion 46 mentioned earlier is connected to the second negative-side line 44.

A fuse 56 is connected in series to the third relay 38 in the third circuit 36. In more detail, the fuse 56 is provided in the third circuit 36 that connects the first negative-side line 28 upstream of the first relay 30 and the second positive-side line 32 upstream of the second relay 34. In the first embodiment, the fuse 56 is provided on the first negative-side line 28-side of the third relay 38.

Here, in the electrical circuit described above in the power distribution apparatus 10, the first positive and negative side lines 40, 28, the second positive and negative-side lines 32, 44 and the like that connect the first, second and third relays 30, 34, 38, the first and second current sensors 52, 54, and the fuse 56 should be made of conductive materials. These lines may be constructed by electric wires or the like, for example, but in this first embodiment, the lines are composed of a plurality of bus bars (hereinafter, bus bars 58a to 58n).

That is, as depicted in FIGS. 1 to 5, the power distribution apparatus 10 includes the bus bar 58a equipped with the first positive-side input portion 16. A stud bolt is press-fitted and fixed to one end (the rear end) in the length direction of the bus bar 58a so as to protrude upward, with the first positive-side input portion 16 being formed by this upward-protruding stud bolt. The bus bar 58a constructs the first positive-side line 40, and the first current sensor 52 is connected to the bus bar 58a. The bus bar 58b is connected downstream of the first current sensor 52, with the first positive-side line 40 being constructed by this bus bar 58b in addition to the bus bar 58a mentioned above.

The power distribution apparatus 10 also includes the bus bar 58c equipped with the first negative side input portion 18. A stud bolt is press-fitted and fixed to one end (the rear end) in the length direction of the bus bar 58c so as to protrude upward, with the first negative side input portion 18 being formed by this upward protruding stud bolt. The bus bar 58c constructs the first negative-side line 28, and the first relay 30 is connected to the bus bar 58c. The bus bar 58d is connected downstream of the first relay 30, with the first negative side line 28 being constructed by this bus bar 58d in addition to the bus bar 58c mentioned above.

A bus bar 58e is connected to and branches off from the first negative-side line 28 upstream of the first relay 30 (that is, at the bus bar 58c), and this bus bar 58e is connected via a bus bar 58f to the fuse 56. The fuse 56 is connected in series via a bus bar 58g to the third relay 38, and the third relay 38 is further connected to a bus bar 58h. This bus bar 58h is connected to the second positive-side line 32 (to a bus bar 58i described later) upstream of the second relay 34. Accordingly, the third circuit 36 is composed of the third relay 38, the fuse 56, and the bus bars 58e, 58f, 58g, and 58h.

The power distribution apparatus 10 also includes the bus bar 58i equipped with the second positive side input portion 22. A stud bolt is press-fitted and fixed to one end (the rear end) in the length direction of the bus bar 58i so as to protrude upward, with the second positive side input portion 22 being formed by this upward protruding stud bolt. The bus bar 58i constructs the second positive-side line 32, and the second relay 34 is connected to the bus bar 58i. The bus bar 58j is connected downstream of the second relay 34, with the second positive-side line 32 being constructed by this bus bar 58j in addition to the bus bar 58i mentioned above.

The power distribution apparatus 10 also includes the bus bar 58k equipped with the second negative side input portion 24. A stud bolt is press-fitted and fixed to one end (the rear end) in the length direction of the bus bar 58k so as to protrude upward, with the second negative side input portion 24 being formed by this upward protruding stud bolt. The bus bar 58k constructs the second negative-side line 44, and the second current sensor 54 is connected to the bus bar 58k. The bus bar 58l is connected downstream of the second current sensor 54, with the second negative-side line 44 being constructed by the bus bar 58l in addition to the bus bar 58k.

In this configuration, downstream of the second relay 34, the first positive-side line 40 (the bus bar 58b) and the second positive-side line (the bus bar 58j) are connected in parallel by the bus bar 58m that constructs the positive-side connector portion 42. The bus bar 58m is a relatively long bus bar that extends in the left-right direction inside the power distribution apparatus 10, with the bus bar 58b and the bus bar 58j being connected to both ends in the length direction (the left-right end parts) of the bus bar 58m. Although these bus bars 58b and 58j may be connected by fixing to the bus bar 58m using bolts or the like, in this first embodiment, the bus bars 58b, 58j, and 58m are integrally formed.

Forward extending portions 60, which extend forward, are integrally provided at a lower end of the bus bar 58m, and in the first embodiment, four forward extending portions 60 are provided at approximately equal intervals so as to be spaced apart in the left right direction. A positive-side external connection bus bar 64, which constructs a positive-side output portion 48, is connected via a fuse 62 to an extending end (that is, the front end) of each forward extending portion 60, and each positive-side external connection bus bar 64 is connected to an anode-side (that is, the positive-side) input portion of a load (auxiliary device), not depicted. Note that although only one positive-side output portion 48 is depicted in FIGS. 13 to 15, FIGS. 13 to 15 are intended to clearly illustrate the electrical configuration of the power distribution apparatus 10, and in reality, the part downstream of the positive-side connector portion 42 branches into four to provide four positive-side output portions 48.

Downstream of the first relay 30, the first negative-side line 28 (the bus bar 58d) and the second negative-side line 44 (the bus bar 58l) are connected in parallel by the bus bar 58n that constructs the negative-side connector portion 46. The bus bar 58n is a relatively long bus bar that extends in the left right direction inside the power distribution apparatus 10, with the bus bar 58d and the bus bar 58l being connected to both ends in the length direction (the left right end parts) of the bus bar 58n. Although these bus bars 58d and 58l may be connected by fixing to the bus bar 58n using bolts or the like, in this first embodiment, the bus bars 58d, 58l, and 58n are integrally formed. The bus bar 58n is spaced apart from the bus bar 58m described earlier in the front-rear direction and extends substantially in parallel to the bus bar 58m. In the first embodiment, the bus bar 58m is positioned closer to the front than the bus bar 58n.

Negative-side external connection bus bars 66, which extend forward and constructs the negative-side output portions 50, are connected to an upper end of the bus bar 58n. Although the negative-side external connection bus bars 66 may be connected by fixing to the bus bar 58n by bolts or the like, in this first embodiment, the negative side external connection bus bars 66 and the bus bar 58n are integrally formed. In the first embodiment, four negative-side external connection bus bars 66 are spaced at approximately equal intervals in the left right direction, and each negative-side external connection bus bar 66 is connected to the cathode side (that is, the negative side) input portion of a load (auxiliary device), not depicted. Note that although only one negative-side output portion 50 is depicted in FIGS. 13 to 15, FIG. 13 to 15 are intended to clearly illustrate the electrical configuration of the power distribution apparatus 10, and in reality, the part downstream of the negative-side connector portion 46 branches into four to provide four negative-side output portions 50.

### First Base Member 68 and Second Base Member 70

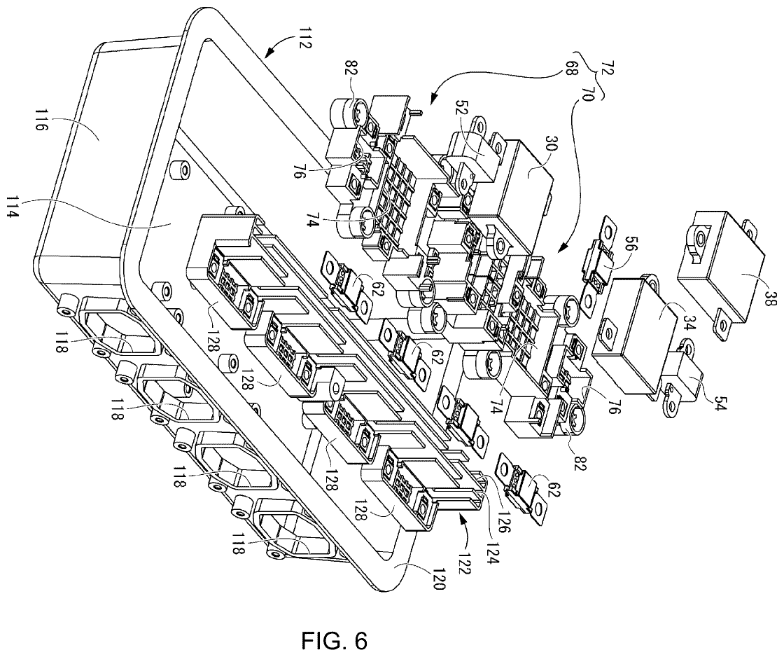

As also depicted in FIGS. 6 to 9, the power distribution apparatus 10 includes a first base member 68 on which the first circuit 20 is mounted and a second base member 70 on which the second circuit 26 is mounted. Note that in FIGS. 6 to 9, the bus bars 58a to 58n, the positive and negative side external connection bus bars 64, 66, and bolts and the like for connecting and fixing purposes are not depicted. In FIGS. 6 to 9, the first base member 68 and the second base member 70 are depicted as being connected to each other in the left right direction as a connected structure 72. In the first embodiment, the first base member 68 is positioned on the left, and the second base member 70 is positioned on the right. In this first embodiment in particular, the first base member 68 and the second base member 70 have the same shape. For this reason, in the following explanation, the form of the first base member 68 will be described and the second base member 70 is assigned the same reference numerals as the first base member 68 in the drawings, with detailed description thereof being omitted.

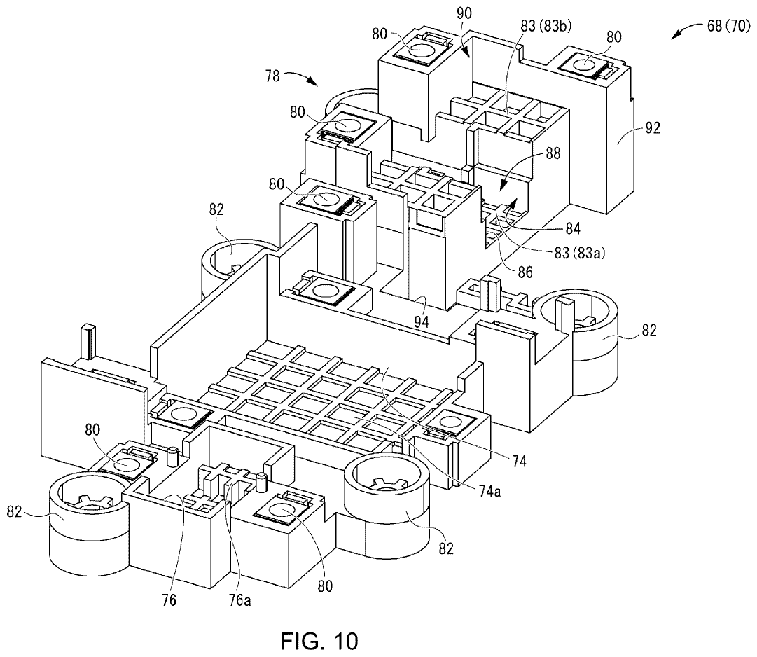

As depicted in FIGS. 10 to 12, the first base member 68 includes a relay mounting portion 74, on which the first relay 30 of the first circuit 20 is mounted, a current sensor mounting portion 76, on which the first current sensor 52 of the first circuit 20 is mounted, and an additional mounting portion 78. That is, on the second base member 70, the second relay 34 in the second circuit 26 is mounted on the relay mounting portion 74, and the second current sensor 54 in the second circuit 26 is mounted on the current sensor mounting portion 76. The second base member 70 also includes an additional mounting portion 78.

In more detail, the first base member 68 has an overall shape of a substantially rectangular plate and is made of an electrically insulating material, such as synthetic resin. As depicted in FIG. 6 and the like, the first base member 68 is fixed to a lower case 112 (described later) in an orientation where its length direction is in the left right direction. That is, the left right dimension of the first base member 68 is larger than the front-rear dimension, and for the first base member 68 (and the second base member 70), the “length direction” is the left-right direction and the “width direction” is the front-rear direction.

The relay mounting portion 74, which is substantially rectangular in shape in plan view, is provided at an intermediate part in the length direction (the left right direction) of the first base member 68, and the current sensor mounting portion 76, which is also substantially rectangular in shape in plan view, is provided at the other end (the left side) in the length direction. The additional mounting portion 78, which is substantially rectangular in shape in plan view, is provided on a first end (the right side) in the length direction of the first base member 68. The relay mounting portion 74 and the current sensor mounting portion 76 are formed as recesses that are open upwards and are constructed by surrounding wall portions that protrude upward from bottom portions 74a, 76a on which the first relay 30 and the first current sensor 52 are respectively mounted.

Note that on the first base member 68, a plurality of nuts 80 are provided in the peripheries of the relay mounting portion 74 and the current sensor mounting portion 76 for bolting the first relay 30, the first current sensor 52, the bus bars that construct the first circuit 20 and the like to the first base member 68. In addition, a plurality of leg portions 82 are provided at the outer peripheral parts of the first base member 68 so as to be spaced apart in the circumferential direction, with the first base member 68 being bolted to the lower case 112, described later, by bolts that are inserted through these leg portions 82.

### Additional Mounting Portion 78

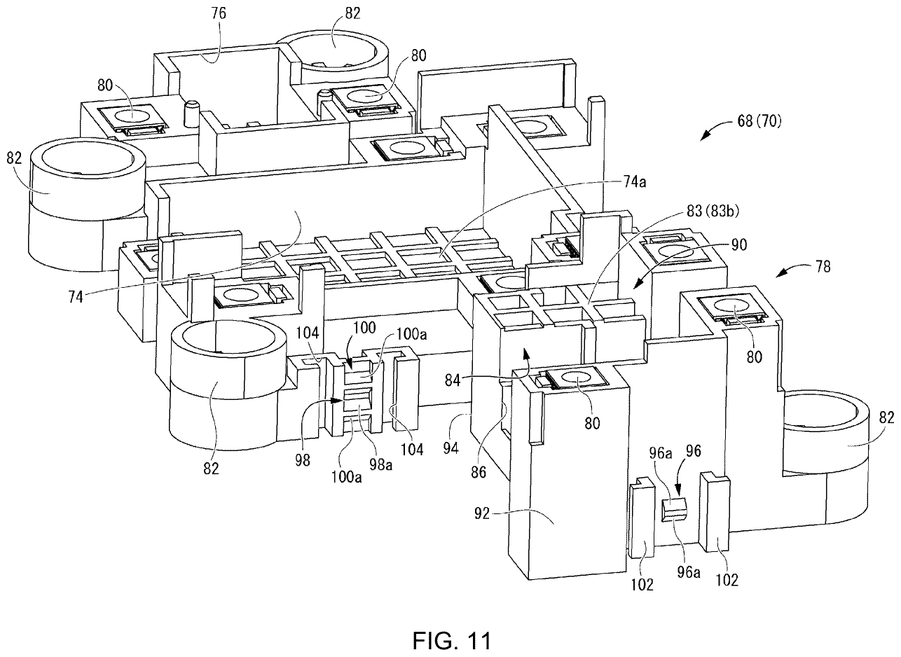

The additional mounting portion 78 has a width dimension (front-rear dimension) that is smaller than the other end in the length direction of the first base member 68, in particular, the relay mounting portion 74 adjacent to the other end (the left side) in the length direction from the additional mounting portion 78, and is off center toward one side in the width direction (the rear side) relative to the relay mounting portion 74. In other words, at the rear part of the relay mounting portion 74, the additional mounting portion 78, which has a smaller width dimension (front-rear dimension) than the relay mounting portion 74, extends toward one end (the right end) in the length direction. Like the relay mounting portion 74 and the current sensor mounting portion 76, the additional mounting portion 78 has a recess constructed by surrounding wall portions that protrude upward from a bottom portion 83. As depicted in FIGS. 10 and 11, the surrounding walls that construct this recess are provided mainly on three sides (the rear and both the left and right sides) that exclude the front, so that the recess provided at the additional mounting portion 78 has a front opening 84.

In the first embodiment, a stepped portion 86 is provided in a part at the center in the left-right direction and at the front of the bottom portion 83 of the recess provided at the additional mounting portion 78. By doing so, the part at the center in the left-right direction and at the front of the bottom portion 83 is positioned lower in the vertical direction than other parts of the bottom portion 83 (see, for example, the additional mounting portion 78 of the second base member 70 depicted in FIG. 9). That is, the bottom portion 83 is constituted by a first bottom portion 83a, which is located at a lower position, and a second bottom portion 83b, which is located higher than the first bottom portion 83a via the stepped portion 86 disposed around the periphery of the first bottom portion 83a.

As described later, by combining the first base member 68 and the second base member 70, the additional mounting portions 78 are interconnected to form a third circuit mounting portion 106 on which the third circuit 36 is mounted. That is, the third circuit mounting portion 106 is configured for mounting the third relay 38 and the fuse 56 that compose the third circuit 36, with the third circuit mounting portion 106 including a third relay mounting portion 110 on which the third relay 38 is mounted and a fuse mounting portion 108 on which the fuse 56 is mounted.

As described later, the fuse mounting portion 108 is constructed by interconnecting the recess including the first bottom portion 83a in the first base member 68 and the recess including the first bottom portion 83a in the second base member 70 in the front-rear direction. That is, the recess including the first bottom portion 83a of the first base member 68 is configured as a fuse mounting portion half portion 88 that cooperates with the recess including the first bottom portion 83a in the second base member 70 to form the fuse mounting portion 108. In the same way, the third relay mounting portion 110 is constructed by interconnecting, in the front-rear direction, a recess including the second bottom portion 83b of the first base member 68 and a recess including the second bottom portion 83b of the second base member 70. That is, the recess including the second bottom portion 83b of the first base member 68 is configured as a third relay mounting portion half portion 90 that cooperates with the recess including the second bottom portion 83b of the second base member 70 to form the third relay mounting portion 110.

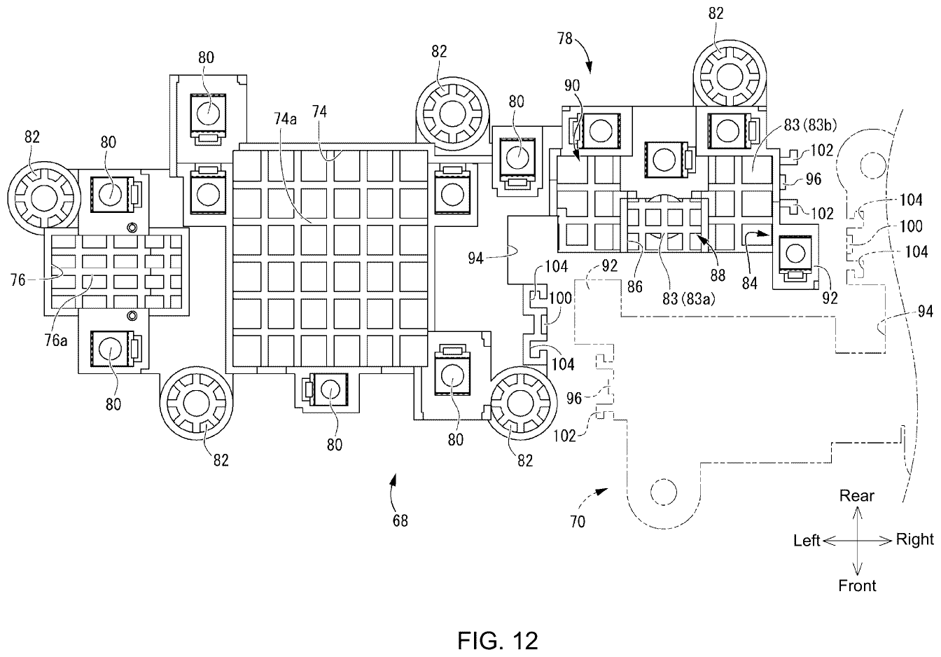

In addition, a mating portion 92 with a polygonal cross section is provided at one end (the right end) in the length direction of an inner edge of the additional mounting portion 78 in the width direction (the front-rear direction), that is the other end (front end) of the additional mounting portion 78 in the width direction. In addition, at this other end (front end) in the width direction (front-rear direction) of the additional mounting portion 78, a mating hole 94, which has the same cross-sectional shape as the mating portion 92 and into which a mating portion 92 fits, is provided at the other end (the left end) in the length direction. In the first embodiment, as depicted in FIG. 12 and the like, the mating portion 92 and the mating hole 94 are both rectangular in plan view.

Outer peripheral surfaces, and in particular right end surfaces of the first base member 68, which become overlapping surfaces when the first base member 68 and the second base member 70 are combined, are provided with a locking protrusion 96 and a locking recess 98 that fit together, as depicted in FIGS. 9 and 11. In more detail, the “right end surfaces of the first base member 68” referred to here are composed of the right end surface of the additional mounting portion 78 and the right end surface of a part of the relay mounting portion 74 where the additional mounting portion 78 is not provided (that is, the front part of the relay mounting portion 74). The locking protrusion 96, which protrudes to the right, is provided on the right end surface of the additional mounting portion 78, and a locking recess 98, which is open rightwards, is provided in the right end surface of the front part of the relay mounting portion 74.

As depicted in FIG. 9, in the first embodiment, a vertical cross section of the locking protrusion 96 is trapezoidal, and in particular, isosceles trapezoidal in the first embodiment. With this shape, both the upper and lower surfaces of the locking protrusion 96 are inclined surfaces 96a, 96a that gradually approach each other in the protruding direction (the rightward direction). In addition, a pair of trapezoidal protrusions 100, 100 that are spaced apart in the vertical direction are provided on the right end surface of the front part of the relay mounting portion 74, so that the locking recess 98, which is recessed relative to the trapezoidal protrusions 100, is formed in the vertical direction between the trapezoidal protrusions 100, 100. A vertical cross section of each trapezoidal protrusion 100 is an isosceles trapezoid, in the same way as the locking protrusion 96. For this reason, the upper and lower surfaces on the inside of the locking recess 98 are inclined surfaces 98a, 98a that gradually separate from each other in the rightward direction, and the upper and lower outer surfaces of the upper and lower trapezoidal protrusions 100 that form the locking recess 98 are inclined surfaces 100a, 100a that gradually approach each other in the rightward direction.

By forming the locking protrusion 96 and the locking recess 98 (the respective trapezoidal protrusions 100) with the shapes described above, as described later, the guiding action of the inclined surfaces 96a, 100a enables the locking protrusion 96 to be inserted into the locking recess 98 from above or from below. When the first base member 68 and the second base member 70 are assembled, the locking protrusion 96 mates with the locking recess 98 and the inclined surfaces 96a of the locking protrusion 96 abut the inclined surfaces 98a of the locking recess 98. By doing so, displacement of the first base member 68 and the second base member 70 in a direction of separation (that is, the vertical direction in which the first base member 68 and the second base member 70 are assembled) is somewhat limited.

As depicted in FIGS. 11 and 12, on the right end surface of the additional mounting portion 78, a pair of hook shaped protrusions 102, 102, which extend in the vertical direction with L-shaped cross sections, are provided on the opposite sides in the front-rear direction of the locking protrusion 96. Each hook-shaped protrusion 102 protrudes rightward from the right end surface of the additional mounting portion 78. In addition, on the right end surface of the front part of the relay mounting portion 74, a pair of hook-shaped recesses 104, 104, which extend in the vertical direction with the same L shaped cross-sectional shapes as the hook-shaped protrusions 102, are provided on the opposite sides in the front-rear direction of the locking recess 98 and the trapezoidal protrusions 100. These hook-shaped recesses 104 are open rightwards on the right end surface in the front part of the relay mounting portion 74, and the hook shaped protrusions 102 can be inserted into the hook-shaped recesses 104 from above or below.

### Connected Structure 72

As described earlier, the first base member 68 and the second base member 70 are assembled to form the connected structure 72 depicted in FIGS. 6 to 9. In the first embodiment, the first base member 68 and the second base member 70 have the same shape, and the second base member 70 is formed by rotating the first base member 68 by 180° around a center axis in the plate thickness direction (the vertical direction). In FIG. 12, the second base member 70 formed by rotating the first base member 68 180° around the center axis in the vertical direction is indicated by a two-dot chain line. Although the first base member 68 and the second base member 70 cannot be assembled even if they are brought close to each other in the left-right direction or the front-rear direction due to the mating portions 92, the locking protrusions 96, and/or the hook-shaped protrusions 102 interfering with each other, it is possible to assemble the base members by bringing the members close to each other in the vertical direction.

That is, by bringing the first base member 68 and the second base member 70 close to each other in the vertical direction, the mating portions 92 and the hook-shaped protrusions 102 of the other member are inserted into and mated with the mating holes 94 and the hook-shaped recesses 104. The respective locking protrusions 96 pass over the trapezoidal protrusions 100 of the other member from above or below and are inserted into the locking recesses 98 to mate together. Although doing so assembles the first base member 68 and the second base member 70, this state is a provisionally fixed state, and this mating of the base members can be released by vertically separating the first base member 68 and the second base member 70. The first base member 68 and the second base member 70 become fully fixed together by placing the fuse 56 on a fuse mounting portion 108, described later, and bolting the fuse 56 to the first base member 68 and the second base member 70. That is, the first base member 68 and the second base member 70 are permanently fixed together by being bolted together via the fuse 56. Note that since the hook-shaped protrusions 102 and the hook-shaped recesses 104 are hook-shaped and correspond to each other, the hook-shaped protrusions 102 and the hook-shaped recesses 104 fit together to prevent the first base member 68 and the second base member 70 from becoming separated in the left right direction.

Here, by assembling the first base member 68 and the second base member 70, the additional mounting portion 78 of the first base member 68 and the additional mounting portion 78 of the second base member 70 become connected so that their front openings 84, 84 overlap each other. By connecting these additional mounting portions 78, the third circuit mounting portion 106 on which the third circuit 36 is mounted is formed.

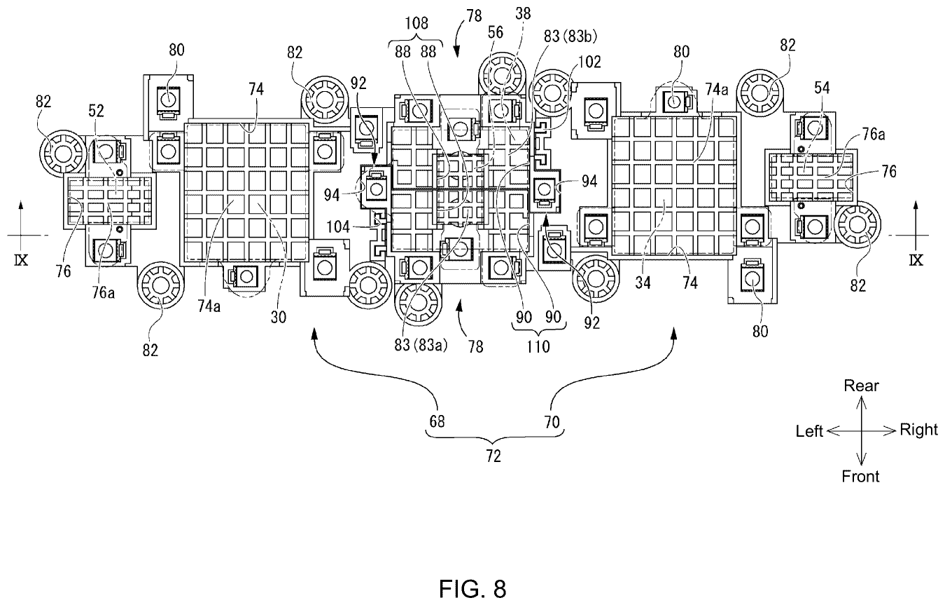

In more detail, in the connected structure 72 in which the first base member 68 and the second base member 70 are connected, the recesses in the additional mounting portions 78 become connected. As described earlier, the recess in the additional mounting portion 78 includes the fuse mounting portion half portion 88 including the first bottom portion 83a and the third relay mounting portion half portion 90 including the second bottom portion 83b. As depicted in FIG. 8, the additional mounting portions 78 are connected in the front-rear direction, so that the fuse mounting portion half portions 88 become connected to each other in the front-rear direction to form the fuse mounting portion 108 that is open upwards. The third relay mounting portion half portions 90 are connected to each other in the front-rear direction to form the third relay mounting portion 110 that is open upwards. By doing so, the third circuit mounting portion 106 is configured to include the fuse mounting portion 108 and the third relay mounting portion 110. The third relay mounting portion 110 is formed above the fuse mounting portion 108.

In FIG. 9, the fuse 56 to be mounted on the fuse mounting portion 108 and the third relay 38 mounted on the third relay mounting portion 110 are indicated by two-dot chain lines. The fuse 56 is placed on the fuse mounting portion 108 from above and fixed with bolts, which mounts the fuse 56 on the fuse mounting portion 108. The third relay 38 is placed on the third relay mounting portion 110 from above and fixed with bolts, which mounts the third relay 38 on the third relay mounting portion 110. Accordingly, in the first embodiment, in a projection in the mounting direction of the fuse 56 (that is, the vertical direction), the third relay mounting portion 110 includes the fuse mounting portion 108 and the periphery of the fuse mounting portion 108. In other words, the region where the third relay 38 is disposed and the region where the fuse 56 is disposed overlap in the mounting direction of the third relay 38 (that is, the vertical direction). As a result, the third relay 38 mounted on the third relay mounting portion 110 overlaps the fuse 56 in the mounting direction of the third relay 38 (that is, the vertical direction). Note that the region where the third relay 38 is disposed (the “third relay mounting portion 110”) and the region where the fuse 56 is disposed (the “fuse mounting portion 108”) do not need to completely overlap in a projection in the vertical direction, and may only partially overlap.

### Lower Case 112 and Holder 122

The connected structure 72 on which the first circuit 20, the second circuit 26, and the third circuit 36 are mounted is fixed to the lower case 112, which is open upwards. As depicted in FIGS. 1 and 6, the lower case 112 is box-shaped with an opening facing upward, and is made of an electrically insulating material, such as synthetic resin. The lower case 112 includes a bottom wall 114 and an annular peripheral wall 116 that protrudes upward from the bottom wall 114. Through holes 118 are provided in the front part of the peripheral wall 116, and electric wires, bus bars, and the like on the load (auxiliary device) side (not depicted) are inserted into the lower case 112 through the through holes 118 and connected to the positive and negative side external connection bus bars 64, 66. In the first embodiment, four insertion holes 118 are provided at approximately equal intervals in the left-right direction in the front part of the peripheral wall 116, corresponding to the positive and negative-side external connection bus bars 64 and 66. A flange-shaped portion 120 that extends annularly around the outer circumference is provided at the upper end of the peripheral wall 116, and the stud bolts that construct the first positive and negative side input portions 16 and 18 and the second positive and negative-side input portions 22 and 24 are placed on the flange-shaped portion 120 and protrude upward.

Additionally, the bus bars 58m, 58n that construct the downstream parts of the first circuit 20 and the second circuit 26 are supported by a holder 122 provided inside the lower case 112. The holder 122 is a relatively long member that extends in the left-right direction inside the lower case 112, and is formed of an electrically insulating material such as synthetic resin. In more detail, the holder 122 has a front channel portion 124 and a rear channel portion 126 that extend in the left right direction and are spaced apart from each other in the front-rear direction, with the bus bar 58m inserted into and supported by the front channel portion 124 and the bus bar 58n inserted into and supported by the rear channel portion 126. In addition, fuse fixing portions 128 for fixing the fuses 62 connected to the forward extending portions 60 are integrally provided on a front part of the holder 122, and in the first embodiment, four fuse fixing portions 128 corresponding to the fuses 62 are provided so as to be spaced apart in the left right direction. The holder 122 described above is fixed by bolts to the bottom wall 114 of the lower case 112.

### Method of Assembling the Power Distribution Apparatus 10

A specific example of a method of assembling the power distribution apparatus 10 is described below. Note that the method of assembling the power distribution apparatus 10 is not limited to the description given below.

First, the first base member 68 and the second base member 70 are prepared. Note that in the first embodiment, since the first base member 68 and the second base member 70 have the same shape, two first base members 68 are prepared, and preparation of the first base member 68 and the second base member 70 is completed by rotating one of the members by 180° around a center axis in the vertical direction. After this, the first base member 68 and the second base member 70 are brought close to each other from a facing state in the vertical direction, the mating portions 92 are inserted into the mating holes 94, and the hook-shaped protrusions 102 are inserted into the hook-shaped recesses 104. Additionally, the inclined surfaces 96a of the locking protrusions 96 contact the inclined surfaces 100a of the trapezoidal protrusions 100, which causes the locking protrusions 96 and/or the trapezoidal protrusions 100 to elastically deform, so that the locking protrusions 96 pass over the trapezoidal protrusions 100 and fit into the locking recesses 98. By doing so, the first base member 68 and the second base member 70 are connected in a provisionally fixed state to form the connected structure 72.

After this, the connected structure 72 in the provisionally fixed state is bolted to the bottom wall 114 of the lower case 112, and the fuse 56 is bolted to the fuse mounting portion 108, thereby permanently fixing the first base member 68 and the second base member 70 together. Note that this bolting of the fuse 56 to the fuse mounting portion 108 may be performed before the connected structure 72 is fixed to the bottom wall 114 of the lower case 112, or the connected structure 72 that has been permanently fixed may be bolted to the bottom wall 114 of the lower case 112. In addition, the holder 122 is fixed by bolts to the bottom wall 114 of the lower case 112. The first to third relays 30, 34, and 38, the first and second current sensors 52 and 54, the bus bars 58a to 58n, the fuses 62, and the positive and negative-side external connection bus bars 64 and 66 which construct the first to third circuits 20, 26, and 36 are placed on the connected structure 72 and the holder 122 in an appropriate order and are respectively fixed with bolts. By doing so, the power distribution apparatus 10 according to the first embodiment is complete. Note that an upper case (not illustrated) may be placed over the lower case 112 of the power distribution apparatus 10 from above, and the upper opening of the lower case 112 may be covered by this upper case.

In the power distribution apparatus 10 manufactured as described above, by turning ON the first and second relays 30, 34 and turning OFF the third relay 38, the electrical configuration depicted in FIG. 14 is produced. That is, in the state depicted in FIG. 14, the first positive-side line 40 from the first battery 12 and the second positive-side line 32 from the second battery 14 are connected in parallel by the positive-side connector portion 42. In addition, the first negative-side line 28 from the first battery 12 and the second negative-side line 44 from the second battery 14 are connected in parallel at the negative-side connector portion 46. By doing so, a voltage of 48 V, which is the same voltage as the first battery 12 and the second battery 14, is applied to each load (auxiliary device) connected to the positive-side output portion 48 and the negative-side output portion 50.

By turning OFF the first and second relays 30 and 34 and turning ON the third relay 38, the electrical configuration depicted in FIG. 15 is produced. That is, in the state depicted in FIG. 15, the first negative-side line 28 and the second positive-side line 32 are connected in series via the third circuit 36. By doing so, the first battery 12 and the second battery 14 are connected in series, the first positive-side line 40 from the first battery 12 is connected via the positive-side output portion 48 to each load (auxiliary device), and the second negative side line 44 from the second battery 14 is connected via the negative side output portion 50 to each load (auxiliary device). As a result, a voltage of 96 V, which is the sum of the voltages of the first battery 12 and the second battery 14, is applied to each load (auxiliary device) connected to the positive side output portion 48 and the negative-side output portion 50.

Accordingly, by using an electrical configuration like that of the first embodiment, it is possible to switch between a series and parallel connection of the first battery 12 and the second battery 14 by selecting ON and OFF for three relays, namely the first to third relays 30, 34, and 38. In particular, when attempts were made to realize a series-parallel switching mechanism for a first battery and second battery like the present disclosure by providing a first relay and a second relay on each of the first positive side line and the second positive side line, there was an increase in the required number of relays, which risked an increase in cost and size. In contrast, in the first embodiment, a configuration is adopted in which the first relay 30 is provided on the first negative-side line 28 and the second relay 34 is provided on the second positive side line 32. By connecting the first negative-side line 28 upstream of the first relay 30 and the second positive-side line 32 upstream of the second relay 34 with a third circuit 36 that includes the third relay 38, it becomes possible to switch between series and parallel connection of the first battery 12 and the second battery 14. For this reason, in the first embodiment, a mechanism for switching between series and parallel between the first battery 12 and the second battery 14 can be realized by adding a single relay (the third relay 38) to a basic structure including the first relay 30 and the second relay 34, thereby avoiding excessive increases in cost and size.

The power distribution apparatus 10 is also configured so that the first current sensor 52 is connected to the first positive-side line 40 of the first circuit 20, and the second current sensor 54 is connected to the second negative side line 44 of the second circuit 26. By doing so, as depicted in FIGS. 14 and 15, regardless of whether the first battery 12 and the second battery 14 are connected in series or parallel, the current values on the first positive-side line 40 and the second negative-side line 44 can be grasped, making it possible to monitor the current values with greater accuracy.

The third circuit 36 includes a third relay 38 and a fuse 56 connected in series to the third relay 38, and the region where the third relay 38 is disposed (the “third relay mounting portion 110”) and the region where the fuse 56 is disposed (the “fuse mounting portion 108”) overlap in the vertical direction. By doing so, the planar shape of the power distribution apparatus 10 becomes smaller compared to a configuration where a region where the third relay 38 is disposed and a region the fuse 56 is disposed are separately provided in a plan view, making it possible to make the power distribution apparatus 10 more compact. When in particular the first battery 12 and the second battery 14 are connected in series, the third circuit 36 will be in a conductive state and has a relatively large voltage applied to it. For the present configuration however, the application of an unexpected excessive voltage will blow the fuse 56, which prevents damage to devices on the circuit.

The power distribution apparatus 10 includes the first base member 68 on which the first circuit 20 is mounted and a second base member 70 on which the second circuit 26 is mounted, with the first base member 68 and the second base member 70 both including an additional mounting portion 78. By assembling the first base member 68 and the second base member 70, the respective additional mounting portions 78, 78 become connected to form the third circuit mounting portion 106 on which the third circuit 36 is mounted. In other words, there is no need to provide a separate base member on which the third circuit 36 is mounted, which avoids an increase in the number of parts.

In particular, the third circuit mounting portion 106 includes the fuse mounting portion 108 and the third relay mounting portion 110, and the fuse 56 mounted on the fuse mounting portion 108 and the third relay 38 mounted on the third relay mounting portion 110 are stacked in the vertical direction. In other words, since the fuse 56 and the third relay 38 are stacked in the vertical direction, and the fuse mounting portion 108 and the third relay mounting portion 110 on which such components are mounted are formed by a combination of the first base member 68 and the second base member 70, it is possible to both miniaturize the power distribution apparatus 10 and achieve a reduction in the number of parts.

In the first embodiment, the first base member 68 and the second base member 70 have the same shape, and the base members 68, 70 each have a mating portion 92 and a mating hole 94 that fit into each other. By using the first base member 68 and the second base member 70 that have the same shape, an increase in the number of types of parts is prevented, which reduces cost and the effort required for parts management. In addition, it is also possible to provisionally fix the first base member 68 and the second base member 70 by mating the mating portions 92 with the mating holes 94, and, as one example, making it possible to prevent unintentional separation of the first base member 68 and the second base member 70 when fixing the fuse 56 or the third relay 38 across the first base member 68 and the second base member 70.

In particular, the first base member 68 and the second base member 70 are each provided with a locking protrusion 96 and a locking recess 98 that engage each other, so that separation of the first base member 68 and the second base member 70 is restricted when the first base member 68 and the second base member 70 are assembled. By doing so, it is possible to more reliably prevent the first base member 68 and the second base member 70 from unintentionally separating when fixing the fuse 56 and the third relay 38 across the first base member 68 and the second base member 70.

### Modifications

Although the first embodiment has been described above as a specific example of the present disclosure, the present disclosure is not limited to the specific description given above. All modifications, improvements, and the like that can achieve the object of the present disclosure are included in the present disclosure. As examples, the following modifications of the embodiment are also included within the technical scope of the present disclosure.

Although the first current sensor 52 is connected to the first positive-side line 40 of the first circuit 20, and the second current sensor 54 is connected to the second negative-side line 44 of the second circuit 26 in the embodiment described above, there are no limitations on the locations where the current sensors are disposed. Note that current sensors do not need to be provided in the power distribution apparatus according to the present disclosure.

Although the power distribution apparatus 10 includes the first base member 68 and the second base member 70 that have the same shape in the embodiment described above, the present disclosure is not limited to this configuration. As one example, the first base member and the second base member may have different shapes. In addition, although the fuse mounting portion 108 and the third relay mounting portion 110 overlap each other in the vertical direction, with the fuse 56 positioned below the third relay 38 in the embodiment described above, the present disclosure is not limited to this configuration. That is, for example, one out of the first base member and the second base member may include a fuse mounting portion, and the other out of the first base member and the second base member may include a third relay mounting portion. Note that in the power distribution apparatus according to the present disclosure, the number of base members is not limited to two (that is, the first base member and the second base member) and may be one, or three or more. That is, the power distribution apparatus according to the present disclosure may include one base member on which the first to third circuits are mounted, or may include three base members on which the first to third circuits are separately mounted. Also, in the power distribution apparatus according to the present disclosure, the fuse connected in series to the third relay is not essential.

Although the mating portion 92 and the mating hole 94 are both rectangular in plan view in the embodiment described above, both may be circular in plan view, for example. Note that the mating portion and the mating hole do not need to have corresponding shapes, and as examples, a rectangular mating portion may be fitted into a mating hole that is circular in plan view, or a circular mating portion may be fitted into a mating hole that is rectangular in plan view.

In the power distribution apparatus according to the present disclosure, the mating portion and the mating hole, the locking protrusion and the locking recess, and the hook-shaped protrusions and hook-shaped recesses are not essential. Although the first base member 68 and the second base member 70 are assembled in the vertical direction in the embodiment described above, the present disclosure is not limited to this configuration. As examples, the first base member and the second base member may be combined by abutting each other in the left-right direction or the front-rear direction. In this case, the fuse and the third relay may be fixed across the first base member and the second base member, and also in this case, the first base member and the second base member may be provisionally fixed before fixing of the fuse and the third relay. There are no limitations on the mechanism for provisionally fixing the first base member and the second base member, and this provisional fixing may be realized by mating together recesses and protrusions like in the embodiment described above, by press fitting, or by any other locking mechanism.

There are no limitations on the shapes of the bus bars 58a to 58n, the lower case 112, and the holder 122 in the embodiment described above, and any shapes may be used. The magnitude of the voltage of the first battery and the second battery is not limited to 48 V, and the magnitude of the voltage of the first battery and the second battery may be set arbitrarily.

1. A power distribution apparatus comprising:
a first circuit including a first positive-side input portion and a first negative-side input portion connected to a first battery;
a second circuit including a second positive-side input portion and a second negative-side input portion connected to a second battery;
a first relay connected to a first negative-side line of the first circuit;
a second relay connected to a second positive-side line of the second circuit;
a third circuit that connects the first negative-side line upstream of the first relay and the second positive-side line upstream of the second relay;
a third relay connected to the third circuit;
a positive-side connector portion that connects a first positive-side line and the second positive-side line in parallel downstream of the second relay;
a negative-side connector portion that connects the first negative-side line and a second negative-side line in parallel downstream of the first relay; and
a positive-side output portion and a negative-side output portion connected to respective downstream sides of the positive-side connector portion and the negative-side connector portion.

2. The power distribution apparatus according to claim 1,
further including;
a first current sensor connected to the first positive-side line of the first circuit; and
a second current sensor connected to the second negative-side line of the second circuit,
wherein the positive-side connector portion is connected to the first positive-side line downstream of the first current sensor, and
the negative-side connector portion is connected to the second negative-side line downstream of the second current sensor.

3. The power distribution apparatus according to claim 1,
further comprising a fuse that is connected in series to the third relay of the third circuit,
wherein a region where the third relay is disposed and a region where the fuse is disposed overlap in a mounting direction of the third relay.

4. The power distribution apparatus according to claim 2,
further including;
a first base member on which the first circuit is mounted; and
a second base member on which the second circuit is mounted,
wherein the first base member and the second base member each include a relay mounting portion, a current sensor mounting portion, and an additional mounting portion,
a third circuit mounting portion is formed by connecting the additional mounting portions by assembling the first base member and the second base member together, and
the third circuit is mounted on the third circuit mounting portion.

5. The power distribution apparatus according to claim 4,
further comprising a fuse that is connected in series to the third relay of the third circuit,
wherein the third circuit mounting portion includes: a fuse mounting portion on which the fuse is mounted; and a third relay mounting portion on which the third relay is mounted and which includes, in a mounting direction of the fuse, the fuse mounting portion and a periphery thereof, and
the third relay mounted on the third relay mounting portion overlaps the fuse in the mounting direction of the third relay.

6. The power distribution apparatus according to claim 4,
wherein the first base member and the second base member have a same shape,
the additional mounting portion is disposed at one end in a length direction of each of the base members, the additional mounting portion is provided so as to be off-center toward one side in a width direction and has a width dimension that is smaller than another end in the length direction of each of the base members, an inner edge in the width direction of the additional mounting portion is provided with a mating portion with a polygonal cross-sectional shape at the one end in the length direction of the additional mounting portion, and a mating hole, which has a same cross-sectional shape as the mating portion and into which a mating portion fits, is provided at the other end in the length direction of the additional mounting portion, and
the third circuit mounting portion, which is produced by connecting the additional mounting portions by assembling the first base member and the second base member together, is formed by mating the mating portion and the mating hole of the second base member, which has been disposed in an orientation that is rotated by 180° around a center axis in a plate thickness direction with respect to the disposed orientation of the first base member, with the mating hole and the mating portion of the first base member.

7. The power distribution apparatus according to claim 6,
wherein an outer peripheral surface of each base member is provided with a locking protrusion and a locking recess, and
when the first base member and the second base member are assembled, the locking protrusions mate with the locking recesses and restrict separation of the first base member and the second base member.
